(19) United States
(12) Patent Application Publication
(10) Pub. No.: US 2025/0093596 A1
(43) Pub. Date: Mar. 20, 2025

(54) OPTOELECTRICAL CONNECTOR

(71) Applicant: Sumitomo Electric Industries, Ltd., Osaka (JP)

(72) Inventors: Yasunori ASANO, Osaka-shi (JP); Takeshi INOUE, Osaka-shi (JP)

(73) Assignee: Sumitomo Electric Industries, Ltd., Osaka (JP)

(21) Appl. No.: 18/830,967

(22) Filed: Sep. 11, 2024

(30) Foreign Application Priority Data
Sep. 15, 2023 (JP) 2023-150253

(51) Int. Cl. G02B 6/42

(52) U.S. Cl. CPC G02B 6/4278; G02B 6/423; G02B 6/426

(57) ABSTRACT

An optoelectrical connector includes a plurality of electrical wires each extending along a first direction, a plurality of optical fibers each extending along the first direction, a housing configured to house the plurality of electrical wires and the plurality of optical fibers, and a pressing part configured to be pressable against at least one of each leading end of the plurality of electrical wires or each leading end of the plurality of optical fibers along the first direction. Each leading end of the plurality of electrical wires and each leading end of the plurality of optical fibers are exposed at an end face of the housing.

### CROSS REFERENCE TO RELATED APPLICATIONS

The present application claims priority based on Japanese Patent Application No. 2023-150253, filed on Sep. 15, 2023, the entire content of which are incorporated herein by reference.

### TECHNICAL FIELD

The present disclosure relates to an optoelectrical connector.

### BACKGROUND

JP2017-069166A discloses an example of an electrical connector. This electrical connector includes a first housing and a second housing. In this electrical connector, a plurality of electrical wires held by the second housing are electrically connected to a plurality of electrode pads of a counterpart unit via a plurality of first terminals and a plurality of second terminals loaded in each housing.

### SUMMARY

An optoelectrical connector according to an embodiment of the present disclosure includes a plurality of electrical wires, a plurality of optical fibers, a housing, and a pressing part. Each of the plurality of electrical wires extends along a first direction. Each of the plurality of optical fibers extends along the first direction. The housing includes a plurality of electrical wire housing parts respectively housing the plurality of electrical wires, and a plurality of optical fiber housing parts respectively housing the plurality of optical fibers. The pressing part is configured to be pressable against at least one of the plurality of electrical wires or the plurality of optical fibers along the first direction. Each leading end of the plurality of electrical wires and each leading end of the plurality of optical fibers are exposed at an end face of the housing.

### BRIEF DESCRIPTION OF THE DRAWINGS

FIG. 1 is a schematic perspective view illustrating an optoelectrical connector according to an embodiment;

FIG. 2 is an exploded perspective view of the optoelectrical connector illustrated in FIG. 1;

FIG. 3 is a schematic perspective view illustrating a mating connector fitted to the optoelectrical connector illustrated in FIG. 1;

FIG. 4 is a schematic perspective view illustrating a sub-connector of the optoelectrical connector illustrated in FIG. 1;

FIG. 5 is a schematic cross-sectional view illustrating a plurality of the sub-connectors illustrated in FIG. 4;

FIG. 6A is a schematic cross-sectional view illustrating an optoelectrical connector and a mating connector according to a comparative example, and FIG. 6B is a schematic cross-sectional view illustrating the optoelectrical connector and the mating connector according to the embodiment;

FIG. 7 is a schematic cross-sectional view illustrating an optoelectrical connector and a mating connector according to a first modification;

FIG. 8 is a schematic cross-sectional view illustrating an optoelectrical connector and a mating connector according to a second modification;

FIG. 9A is a schematic cross-sectional view illustrating an optoelectrical connector and a mating connector according to a third modification, FIG. 9B is a schematic cross-sectional view illustrating an optoelectrical connector and a mating connector according to a fourth modification, FIG. 9C is a schematic cross-sectional view illustrating an optoelectrical connector and a mating connector according to a fifth modification, and FIG. 9D is a schematic cross-sectional view illustrating an optoelectrical connector and a mating connector according to a sixth modification; and

FIG. 10 is a schematic cross-sectional view illustrating an optoelectrical connector and a mating connector according to a seventh modification.

### DETAILED DESCRIPTION

An electrical connector described in JP2017-069166A has a configuration in which only electrical wires are placed, and these electrical wires are connected to electrical wires of a mating connector. In contrast, it has been studied to form an optoelectrical connector by replacing some of the electrical wires in the electrical connector with optical fibers to improve transmission capability. However, when the optoelectrical connector in which some of the electrical wires are simply replaced with the optical fibers is fitted to the mating connector, a resistive force applied to leading ends of the electrical wires from the mating connector and a resistive force applied to leading ends of the optical fibers from the mating connector may be different from each other because of a difference in a connection system between both the electrical wires and the optical fibers. In this instance, the load applied to the end face of the optoelectrical connector from the mating connector is not uniform over the entire end face. As a result, the electrical connection between the electrical wires of the optoelectrical connector and conductors of the mating connector may be unstable, or the coupling efficiency of the optical coupling between the optical fibers of the optoelectrical connector and optical fibers of the mating connector may decrease.

According to the present disclosure, it is possible to provide the optoelectrical connector capable of achieving stability of the electrical connection between the electrical wires and maintaining the coupling efficiency of the optical coupling between the optical fibers.

### Description of Embodiment of Present Disclosure

First, contents of embodiments of the present disclosure are listed and described.

(1) An optoelectrical connector according to an embodiment of the present disclosure includes a plurality of electrical wires, a plurality of optical fibers, a housing, and a pressing part. Each of the plurality of electrical wires extends along a first direction. Each of the plurality of optical fibers extends along the first direction. The housing includes a plurality of electrical wire housing parts respectively housing the plurality of electrical wires and a plurality of optical fiber housing parts respectively housing the plurality of optical fibers. The pressing part is configured to be pressable against at least one of the plurality of electrical wires or the plurality of optical fibers along the first direction. Each leading end of the plurality of electrical wires and each leading end of the plurality of optical fibers are exposed at an end face of the housing.

In this optoelectrical connector, the pressing part is configured to be pressable against at least one of each leading end of the plurality of electrical wires or each leading end of the plurality of optical fibers along the first direction. According to such a configuration, it is possible to adjust at least one of the magnitude of a resistive force applied to each leading end of the plurality of electrical wires from the mating connector or the magnitude of a resistive force applied to each leading end of the optical fibers from the mating connector. Therefore, at the end face of the housing, the magnitude of each of the resistive forces can be adjusted so that the load is uniformly applied to each leading end of the plurality of electrical wires and each leading end of the plurality of optical fibers from the mating connector. As a result, it is possible to achieve the stable electrical connection between the electrical wires of the optoelectrical connector and the conductors of the mating connector, and the stable optical coupling between the optical fibers of the optoelectrical connector and the optical fibers of the mating connector. Note that the above phrase of “at least one of each leading end of the plurality of electrical wires or each leading end of the plurality of optical fibers” includes the case of “each leading end of the plurality of electrical wires”, the case of each leading end of the plurality of optical fibers, and the case of “each leading end of the plurality of electrical wires and each leading end of the plurality of optical fibers”. This definition is the same as the following.

(2) In the optoelectrical connector according to (1) described above, the pressing part may be configured to be pressable against at least one of each leading end of the plurality of electrical wires or each leading end of the plurality of optical fibers along the first direction so that a magnitude of a resistive force applied to each leading end of the plurality of electrical wires from a mating connector and a magnitude of a resistive force applied to each leading end of the plurality of optical fibers from the mating connector approximate each other. According to this configuration, at the end face of the housing, the load is uniformly applied to each leading end of the plurality of electrical wires and each leading end of the plurality of optical fibers from the mating connector. Therefore, it is possible to achieve the stable electrical connection between the electrical wires of the optoelectrical connector and the conductors of the mating connector and the stable optical coupling between the optical fibers of the optoelectrical connector and the optical fibers of the mating connector.

(3) In the optoelectrical connector according to (1) or (2) described above, each leading end of the plurality of optical fibers may be included in at least one optical fiber array extending along a second direction intersecting the first direction at the end face of the housing. Each leading end of the plurality of electrical wires may be included in a plurality of signal line arrays extending along the second direction and being adjacent to each other in a third direction intersecting the second direction at the end face of the housing. In this instance, at the end face of the housing, the leading ends of the plurality of optical fibers are clustered within a predetermined region, and the leading ends of the plurality of electrical wires are clustered within another region. Therefore, the magnitude of the resistive force applied to each leading end of the plurality of electrical wires from the mating connector and the magnitude of the resistive force applied to each leading end of the optical fibers from the mating connector can be made to approximate each other more easily.

(4) In the optoelectrical connector according to (1) to (3) described above, the pressing part may further include a first pressing part configured to be pressable against each leading end of the plurality of electrical wires toward a mating connector along the first direction. In this instance, it is possible to increase the resistive force applied to each leading end of the plurality of electrical wires from the mating connector.

(5) In the optoelectrical connector according to (4) described above, the pressing part may further include a second pressing part configured to be pressable against each leading end of the plurality of optical fibers toward the mating connector along the first direction. In this instance, it is possible to increase the resistive force applied to each leading end of the plurality of optical fibers from the mating connector.

(6) In the optoelectrical connector according to (5) described above, a magnitude of a force with which the first pressing part presses each leading end of the plurality of electrical wires may be different from a magnitude of a force with which the second pressing part presses each leading end of the plurality of optical fibers. In this instance, when the resistive force applied to each leading end of the plurality of electrical wires from the mating connector is different from the resistive force applied to each leading end of the plurality of optical fibers from the mating connector, the magnitude of the resistive force applied to each leading end of the plurality of electrical wires from the mating connector and the magnitude of the resistive force applied to each leading end of the optical fibers from the mating connector can be made to approximate each other.

(7) In the optoelectrical connector according to (6) described above, the force with which the first pressing part presses each leading end of the plurality of electrical wires may be greater than the force generated by the second pressing part to press each leading end of the plurality of optical fibers. In this instance, when the resistive force applied to each leading end of the plurality of electrical wires from the mating connector is smaller than the resistive force applied to each leading end of the plurality of optical fibers from the mating connector, the magnitude of the resistive force applied to each leading end of the plurality of electrical wires from the mating connector and the magnitude of the resistive force applied to each leading end of the optical fibers from the mating connector can be made to approximate each other.

(8) In the optoelectrical connector according to any one of (5) to (7) described above, the first pressing part and the second pressing part may be elastic bodies.

(9) In the optoelectrical connector according to (8) described above, the pressing part may include the first pressing part provided at each of the leading ends of the plurality of electrical wires and the second pressing part provided at each of the leading ends of the plurality of optical fibers. A spring constant of the first pressing part may be different from a spring constant of the second pressing part.

(10) In the optoelectrical connector according to any one of (1) to (9), a position of each leading end of the plurality of electrical wires in the first direction and a position of each leading end of the plurality of optical fibers in the first direction may be different from each other. In this instance, the magnitude of the resistive force applied to each leading end of the plurality of electrical wires from the mating connector and the magnitude of the resistive force applied to each leading end of the optical fibers from the mating connector can be adjusted separately from each other.

(11) In the optoelectrical connector according to any one of (1) to (10) described above, the housing may further include a first sub-connector provided with the plurality of electrical wire housing parts and a second sub-connector provided with the plurality of optical fiber housing parts. In this instance, only the leading ends of the plurality of optical fibers are arranged at the end face of the first sub-connector, and only the leading ends of the plurality of electrical wires are arranged at the end face of the second sub-connector. Therefore, the load is uniformly applied from the mating connector at the end face of the first sub-connector and the end face of the second sub-connector.

(12) In the optoelectrical connector according to any one of (1) to (11) described above, the optoelectrical connector may further include at least one guide hole configured to allow insertion of a guide pin to position the housing. At least one of the plurality of electrical wire housing parts or the plurality of optical fiber housing parts is a plurality of through-holes each of which extends along the first direction and penetrates the housing. In this instance, each leading end of the plurality of electrical wires or each leading end of the plurality of optical fibers can be positioned with respect to the mating connector with higher accuracy.

(13) In the optoelectrical connector according to any one of (1) to (12) described above, the plurality of electrical wires may include a plurality of electrical wires of a flexible flat cable.

### Details of Embodiment of Present Disclosure

Specific examples of an optoelectrical connector according to an embodiment of the present disclosure will be described below with reference to the drawings. In the following description, the same reference signs will be used for the same elements or elements having the same functions, and the description will not be repeated to avoid redundancy. Note that, the present invention is not limited to these examples, indicated by the claims, and intended to include all modifications within the meaning and scope equivalent to the claims.

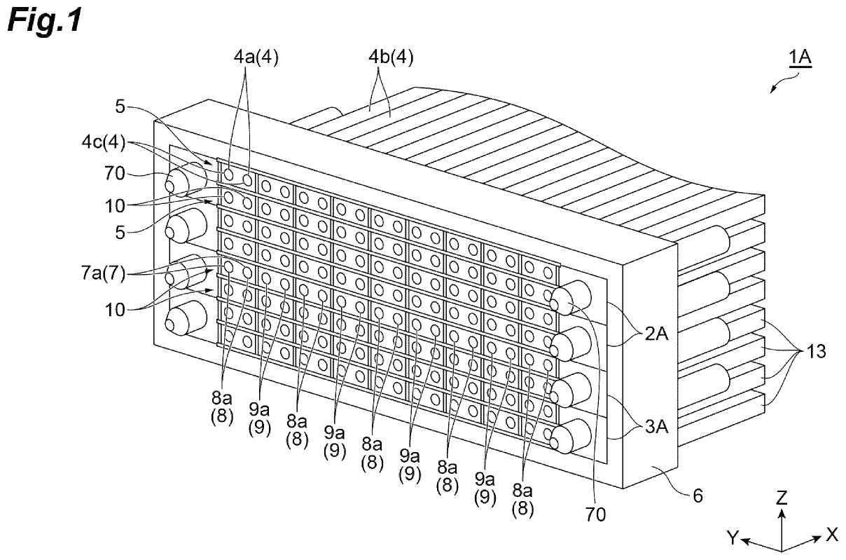

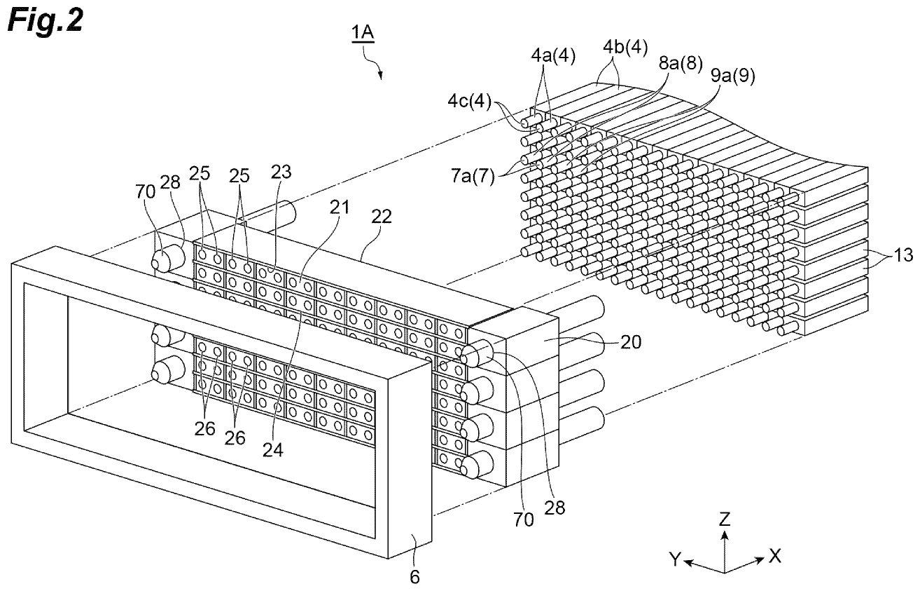

FIG. 1 is a schematic perspective view illustrating an optoelectrical connector 1A according to an embodiment. FIG. 2 is an exploded perspective view of the optoelectrical connector 1A illustrated in FIG. 1. The optoelectrical connector 1A is mounted on a substrate (not shown) via, for example, an optoelectrical connector 1B (described later). The optoelectrical connector 1A includes two sub-connectors 2A (second sub-connectors), two sub-connectors 3A (first sub-connectors), and a frame 6. The sub-connectors 2A and 3A are fitted into the frame 6.

Each of the sub-connectors 2A includes a plurality of optical fibers 4, a housing 20, and a pair of guide pins 70. Each of the optical fibers 4 has an optical fiber core 4a and a resin coating 4b that covers the optical fiber core 4a. In each of the optical fibers 4, the optical fiber core 4a is exposed by removing the resin coating 4b from the middle in the X direction to a leading end 4c. When the optoelectrical connector 1A is connected to the optoelectrical connector 1B, the optical fiber core 4a of an optical fiber 4 provided in the optoelectrical connector 1A is optically coupled to an optical fiber core 4a of an optical fiber 4 provided in the optoelectrical connector 1B. The distance between the optical fiber cores 4a of the two adjacent optical fibers 4 is, for example, 0.6 mm.

Each optical fiber 4 extends along the X direction. The plurality of optical fibers 4 are arranged side by side in the Y direction and Z direction within each of the sub-connectors 2A. The plurality of optical fibers 4 includes, for example, thirty-six optical fibers. Two sets of eighteen optical fibers are arranged in two rows along the Z direction, each set of the eighteen optical fibers in each row being arranged along the X direction. The individual leading ends 4c of the plurality of optical fibers 4 constitute a plurality of optical fiber arrays 5 extending along the Y direction at a first face 21 of the housing 20. Therefore, in the arrangement of optical wires, the optical fibers 4 are clustered within a part of the first face 21 of the housing 20.

The housing 20 is a rectangular parallelepiped member that holds the plurality of optical fibers 4. The housing 20 is formed of, for example, a resin such as polyphenylene sulfide (PPS) or other resins. The housing 20 includes the first face 21, a second face 22, a third face 23, and a fourth face 24. The first face 21 and the second face 22 extend in the Y direction and Z direction. The second face 22 is positioned on the opposite side to the first face 21 in the X direction. The third face 23 and the fourth face 24 extend in the X direction and Y direction. The fourth face 24 is positioned on the opposite side to the third face 23 in the Z direction.

The housing 20 further includes a plurality of through-holes 25 (a plurality of optical fiber housing parts) and a pair of guide holes 28.

Each of the through-holes 25 is a hole extending along the X direction and penetrating the housing 20. Each of the through-holes 25 is opened on the first face 21 and the second face 22. The plurality of through-holes 25 house the plurality of optical fibers 4, respectively. In the present embodiment, in the housing 20, two sets of eighteen through-holes 25 are arranged in two rows along the Z direction, each set of the eighteen through-holes 25 in each row being arranged along the Y direction. The inner diameter of each of the through-holes 25 is the same as or slightly greater than the outer diameter of the optical fiber core 4a of the optical fiber 4. The optical fiber core 4a of the optical fiber 4 is disposed inside each of the through-holes 25. The leading end 4c of the optical fiber core 4a is housed in each of the through-holes 25. The leading end 4c of the optical fiber core 4a is held in each of the through-holes 25. The leading ends 4c of the optical fiber cores 4a of the plurality of optical fibers 4 are respectively exposed through the plurality of through-holes 25 at the first face 21.

The pair of guide holes 28 extends along the X direction and penetrates the housing 20. Each guide hole 28 is configured to allow insertion of a guide pin 70. Therefore, the housing 20 of the optoelectrical connector 1A can be positioned relative to a housing 20 of the optoelectrical connector 1B. In the present embodiment, the guide hole 28 has a circular shape when viewed from the X direction. A pair of guide pins 70 is inserted into the pair of guide holes 28, respectively. The pair of guide holes 28 is formed to sandwich the plurality of through-holes 25 in the Y direction. The inner diameter of each of the pair of guide holes 28 is formed to be greater than the inner diameter of each of the through-holes 25.

Each of the sub-connectors 3A includes a plurality of electrical wires 7, a housing 20, and a pair of guide pins 70. The plurality of electrical wires 7 is integrated by a covering member 13 to form a flexible flat cable (FFC).

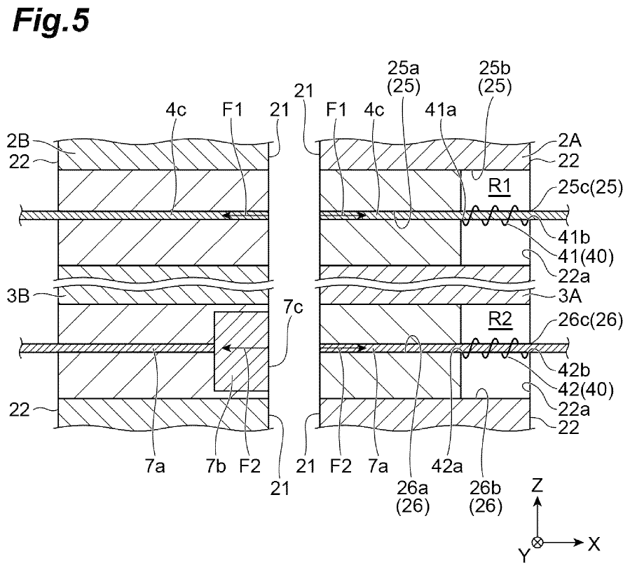

The plurality of electrical wires 7 are members for transmitting electric power or electric signals. Each of the electrical wires 7 is any one of a signal line 8 or a ground line 9. In an example, the plurality of electrical wires 7 includes five pairs of signal lines (ten signal lines) 8 and four pairs of ground lines (eight ground lines) 9. The signal line 8 includes a conductor 8a. The conductor 8a is, for example, a metal such as copper. When the optoelectrical connector 1A is connected to the optoelectrical connector 1B, the conductor 8a is connected to a circuit of the substrate via a terminal 7b (see FIG. 5) provided in the optoelectrical connector 1B. The conductor 8a may be directly connected to an electrode pad provided on the substrate. The signal line 8 may be an insulated electrical wire with the conductor 8a covered with an insulator, or may be a bare electrical wire with the conductor 8a exposed as it is.

The ground line 9 includes a conductor 9a. The conductor 9a is, for example, a metal such as copper. When the optoelectrical connector 1A is connected to the optoelectrical connector 1B, the conductor 9a is connected to a ground via a terminal 7b (see FIG. 5) provided in the optoelectrical connector 1B. The conductor 9a may be directly connected to an electrode pad provided on the substrate. The ground line 9 may be an insulated electrical wire with the conductor 9a covered with an insulator, or may be a bare electrical wire with the conductor 9a exposed as it is.

Each of the plurality of electrical wires 7 extends along the X direction. The plurality of electrical wires 7 are arranged side by side in the Y direction within each of the sub-connectors 3A. In an example, a pair of signal lines 8 and a pair of ground lines 9 are alternately arranged along the Y direction. The pair of adjacent signal lines 8 carry currents of opposite phases to each other, and transmit signals by differential signaling for transmitting signals using a potential difference between the pair of signal lines 8. The distance (distance between the centers) between the conductors of the plurality of electrical wires 7 is, for example, 0.6 mm.

The plurality of electrical wires 7 are arranged side by side not only in the Y direction but also in the Z direction within each of the sub-connectors 3A. The plurality of electrical wires 7 includes, for example, thirty-six electrical wires. Two sets of eighteen electrical wires are arranged in two rows along the Z direction, each set of the eighteen electrical wires in each row being arranged along the X direction. The individual leading ends 7a of the plurality of electrical wires 7 constitute a plurality of signal line arrays 10 extending along the Y direction at the first face 21 of the housing 20. The plurality of signal line arrays 10 are adjacent to each other in the Z direction. Therefore, in the arrangement of metal wires, the electrical wires 7 are clustered within a part of the first face 21 of the housing 20.

The covering member 13 covers each of the plurality of electrical wires 7 excluding a leading end 7a and a tail end. The material of the covering member 13 is, for example, a resin such as polyester. A portion of the covering member 13 covering the leading end 7a of the conductor 8a of the signal line 8 and the leading end 7a of the conductor 9a of the ground line 9 is removed. In other words, the leading end 7a of the conductor 8a of the signal line 8 and the leading end 7a of the conductor 9a of the ground line 9 are exposed without coverage of the covering member 13.

Unlike the housing 20 of the sub-connector 2A, the housing 20 of the sub-connector 3A holds the plurality of electrical wires 7. The housing 20 further includes a plurality of through-holes 26 (a plurality of electrical wire housing parts) and a pair of guide holes 28. Each of the through-holes 26 is a hole extending along the X direction and penetrating the housing 20. Each of the through-holes 26 is opened on the first face 21 and the second face 22. In the present embodiment, in the housing 20, two sets of eighteen through-holes 26 are arranged in two rows along the Z direction, each set of the eighteen through-holes 26 in each row being arranged along the Y direction. The inner diameter of each of the through-holes 26 is the same as or slightly greater than the outer diameter of the conductor 8a of the signal line 8 and the outer diameter of the conductor 9a of the ground line 9. One of the conductor 8a of the signal line 8 or the conductor 9a of the ground line 9 is disposed inside each of the through-holes 26. The leading end of the electrical wire 7 is housed in each of the through-holes 26. Each of the through-holes 26 holds a conductor at the leading end of the electrical wire 7. The leading ends of the plurality of electrical wires 7 are respectively exposed through the plurality of through-holes 26 at the first face 21.

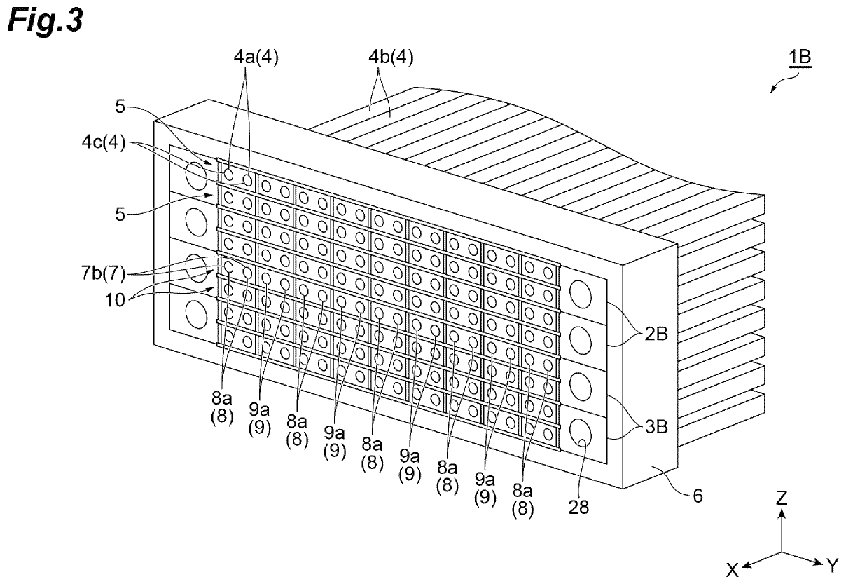

FIG. 3 is a schematic perspective view illustrating the optoelectrical connector 1B configured to be fittable to the optoelectrical connector 1A illustrated in FIG. 1. The optoelectrical connector 1B includes two sub-connectors 2B (second sub-connectors), two sub-connectors 3B (first sub-connectors), and a frame 6. The sub-connectors 2B are different from the sub-connectors 2A in that the guide pin 70 is not included. The sub-connectors 3B are different from the sub-connectors 3A in that the guide pin 70 is not included, and each of the optical fibers 4 has a terminal 7b. In the sub-connector 3B, the terminal 7b is provided at the leading end 4c of the optical fiber 4. A leading end face 7c of the terminal 7b is flush with the first face 21 of the sub-connector 3B (see FIG. 5). The terminal 7b in the sub-connector 3B is configured to be electrically connectable to the leading end 7a of the electrical wire 7 in the sub-connector 3A.

Each of the sub-connectors 2B and each of the sub-connectors 3B may be provided with a pressing part pressing the plurality of optical fibers 4 and the plurality of electrical wires 7 along the X direction. The pressing part may generate a resistive force applied to the plurality of optical fibers 4 and the plurality of electrical wires 7 of the optoelectrical connector 1B from the optoelectrical connector 1A when the optoelectrical connector 1A is fitted to the optoelectrical connector 1B. The pressing part may have a configuration similar to that of a pressing part 40 described later, or may have a configuration different from that of the pressing part 40 described later. The pressing part is, for example, a spring.

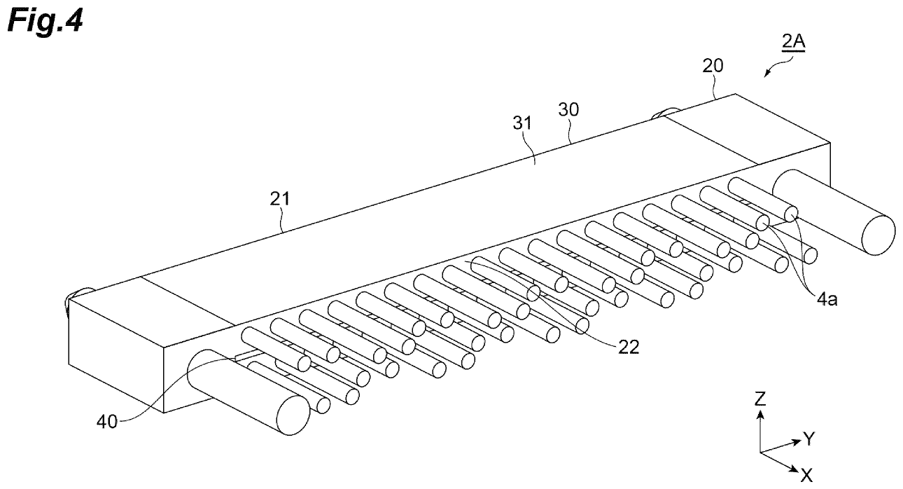

Next, a pressing part pressing the optical fibers 4 and the electrical wires 7 along the X direction will be described in detail with reference to FIGS. 4 and 5. FIG. 4 is a schematic perspective view illustrating the sub-connector 2A included in the optoelectrical connector 1A illustrated in FIG. 1. The sub-connector 3A has the same configuration as that of the sub-connector 2A illustrated in FIG. 4 except that the sub-connector 3A holds the plurality of electrical wires 7 instead of the plurality of optical fibers 4. FIG. 5 is a schematic cross-sectional view of the sub-connectors 2A and 3A and the sub-connectors 2B and 3B along the XZ plane.

As illustrated in FIG. 5, in the sub-connector 2A, the through-hole 25 has a first hole portion 25a and a second hole portion 25b. The first hole portion 25a is opened on the first face 21. The first hole portion 25a extends from the first face 21 along the X direction. The first hole portion 25a has, for example, a circular shape when viewed from the X direction. The second hole portion 25b communicates with the first hole portion 25a in the X direction. The second hole portion 25b extends in the X direction and is opened at a hole 25c on the second face 22. The second hole portion 25b defines an internal space R1. The second hole portion 25b has, for example, a rectangular shape when viewed from the X direction.

In the sub-connector 3A, the through-hole 26 has a first hole portion 26a and a second hole portion 26b. The first hole portion 26a is opened on the first face 21. The first hole portion 26a extends from the first face 21 along the X direction. The first hole portion 26a has, for example, a circular shape when viewed from the X direction. The second hole portion 26b communicates with the first hole portion 26a in the X direction. The second hole portion 26b extends in the X direction and is opened at a hole 26c on the second face 22. The second hole portion 26b defines an internal space R2. The second hole portion 26b has, for example, a rectangular shape when viewed from the X direction.

Each of the sub-connector 2A and sub-connector 3A is provided with a pressing part 40 pressing the plurality of optical fibers 4 and the plurality of electrical wires 7. The pressing part 40 includes a plurality of pressing members 41 (second pressing parts). Each of the plurality of pressing members 41 is configured to be pressable against the leading end 4c of the optical fiber 4 toward the sub-connector 2B along the X direction. The plurality of pressing members 41 correspond to the individual leading ends 4c of the plurality of optical fibers 4, respectively. Each pressing member 41 is disposed in the internal space R1 of the sub-connector 2A. A front end 41a of each pressing member 41 is connected to the leading end 4c of the optical fiber 4. A tail end 41b of each pressing member 41 is connected to an inner surface 22a of the second face 22 of the sub-connector 2A. Each pressing member 41 is, for example, an elastic body, and a spring is exemplified as an example.

The pressing part 40 further includes a pressing member 42 (first pressing part) that presses each electrical wire 7. The pressing member 42 presses each leading end 7a of the plurality of electrical wires 7 toward the sub-connector 3B along the X direction. A plurality of the pressing members 42 correspond to the individual leading ends 7a of the plurality of electrical wires 7, respectively. The pressing member 42 is disposed in the internal space R2 of the sub-connector 3A. A front end 42a of the pressing member 42 is connected to the leading end 7a of the electrical wire 7. A tail end 42b of the pressing member 42 is connected to an inner surface 22a of the second face 22 of the sub-connector 2A. The pressing member 42 is, for example, an elastic body, and a spring is exemplified as an example.

When the optoelectrical connector 1A is fitted to the optoelectrical connector 1B, a resistive force F1 is applied to each leading end 4c of the plurality of optical fibers 4 from each leading end 4c of the plurality of optical fibers 4 of the optoelectrical connector 1B. When the optoelectrical connector 1A is fitted to the optoelectrical connector 1B, a resistive force F2 is applied to each leading end 7a of the plurality of electrical wires 7 from each terminal 7b of the plurality of electrical wires 7 of the optoelectrical connector 1B. As described above, in the optoelectrical connector 1A, the resistive force F1 and the resistive force F2 can be adjusted by providing the plurality of sub-connectors 2A and 3A, and providing the pressing part 40 including a spring or other pressing part, which adjusts the difference between loads (the resistive force F1 and the resistive force F2) applied to each metal wire and each optical wire.

The pressing part 40 is configured to be pressable against each leading end 7a of the plurality of electrical wires 7 and each leading end 4c of the plurality of optical fibers 4 along the X direction so that the magnitude of the resistive force F2 applied to the plurality of electrical wires 7 and the magnitude of the resistive force F1 applied to the plurality of optical fibers 4 approximate each other. In other words, any one of a fitting force generated between optical wires or a fitting force generated between metal wires is adjusted to match the other.

In a first example, when the pressing part 40 is not provided, the magnitude of the resistive force F1 applied to the plurality of optical fibers 4 may be greater than the magnitude of the resistive force F2 applied to the plurality of electrical wires 7. In other words, the fitting force between the optical fibers 4 (optical wires) may be greater than the fitting force between the electrical wires 7 (metal wires). In this instance, the pressing part 40 is provided such that a force with which each pressing member 42 presses each leading end 7a of the plurality of electrical wires 7 is greater than a force with which each pressing member 41 presses each leading end 4c of the plurality of optical fibers 4, thereby the magnitude of the resistive force F1 and the magnitude of the resistive force F2 approximating each other. The term “approximate” as used herein means that the magnitude of the resistive force F1 is the same as or substantially the same as the magnitude of the resistive force F2. For example, a ratio of the magnitude of the resistive force F1 to the magnitude of the resistive force F2 may be from 0.90 to 1.10, and may be from 0.95 to 1.05, and may be 1.00 is exemplified as an example.

As an example, when the pressing part 40 is not provided, the magnitude of the resistive force F1 applied to the optical fibers 4 is 4 N, and the magnitude of the resistive force F2 applied to the electrical wires 7 is 2 N. In this case, the force with which each pressing member 41 presses each leading end 4c of the plurality of optical fibers 4 is set to 1 N to achieve a magnitude of the resistive force F1 of 5 N. On the other hand, the force with which each pressing member 42 presses each leading end 7a of the plurality of electrical wires 7 is set to 3 N to achieve a magnitude of the resistive force F2 of 5 N. In this manner, the magnitude of the resistive force F1 and the magnitude of the resistive force F2 are approximated to each other.

In a second example, when the pressing part 40 is not provided, the magnitude of the resistive force F2 applied to the plurality of electrical wires 7 may be greater than the magnitude of the resistive force F1 applied to the plurality of optical fibers 4. In other words, the fitting force between the electrical wires 7 (metal wires) may be greater than the fitting force between the optical fibers 4 (optical wires). In this instance, the pressing part 40 is provided such that the force with which each pressing member 41 presses each leading end 4c of the plurality of optical fibers 4 is greater than the force with which each pressing member 42 presses each leading end 7a of the plurality of electrical wires 7, thereby the magnitude of the resistive force F1 and the magnitude of the resistive force F2 approximating each other.

Therefore, in the first example and the second example, the magnitude of the force with which each pressing member 42 presses each leading end 7a of the plurality of electrical wires 7 is different from the magnitude of the force with which each pressing member 41 presses each leading end 4c of the plurality of optical fibers 4. For example, a spring constant of each first pressing member 41 is different from a spring constant of each pressing member 42. As an example, a material for forming one of the pressing members 41 and the pressing members 42 is selected (changed) so that the force (reaction force) with which any one of the pressing members 41 or the pressing members 42 press the leading ends 7a of the electrical wires 7 is greater than the force with which the other of the pressing members 41 or the pressing members 42 press the leading ends 7a of the electrical wires 7. For example, the length of the second hole portion 25b of the through-hole 25 along the X direction is different from the length of the second hole portion 26b of the through-hole 26 along the X direction.

Hereinafter, the functional effect of the optoelectrical connector 1A according to the present embodiment will be described. In the conventional electrical connectors, a plurality of electrical wires and a plurality of optical fibers are not wired in the same connector. However, for reasons of such as increasing communication speed for information and communications, expanding frequency bands used for communications, and reducing energy consumption in information and communications, it has been studied to replace some of a plurality of electrical wires with optical fibers.

In such a case, when an optoelectrical connector in which some of electrical wires are simply replaced with optical fibers is fitted to a mating connector, a resistive force applied to leading ends of the electrical wires from the mating connector and a resistive force applied to leading ends of the optical fibers from the mating connector may be different from each other. In other words, a force required to fit metal wires and a force required to fit optical wires can be greatly different from each other. For example, the force required to fit the optical wires to each other is greater than the force required to fit the metal wires to each other. As a result, in the optoelectrical connector in which some of the electrical wires are simply replaced with the optical fibers, the load applied from the mating connector is not uniform over the entire end face. As a result, when the plurality of electrical wires and the plurality of optical fibers are disposed as in the conventional connectors, it can be difficult to achieve the stable electrical connection between the electrical wires of the optoelectrical connector (multipolar connector) and the conductors of the mating connector, and the stable optical coupling between the optical fibers of the optoelectrical connector and the optical fibers of the mating connector. In other words, an unstable connection of a hybrid connector including the optical fibers and the metal conductors occurs during fitting.

In contrast, in the optoelectrical connector 1A according to the present embodiment, the pressing part 40 is configured to be pressable against at least one of each leading end 7a of the plurality of electrical wires 7 or each leading end 4c of the plurality of optical fibers 4 along the X direction. According to such a configuration, it is possible to adjust at least one of the magnitude of the resistive force F2 applied to each leading end 7a of the plurality of electrical wires 7 from the optoelectrical connector 1B or the magnitude of the resistive force F1 applied to each leading end 4c of the optical fibers 4 from the optoelectrical connector 1B. Therefore, at the first face 21 of the housing 20, the magnitude of each of the resistive forces F1 and F2 can be adjusted so that the load is uniformly applied to each leading end 7a of the plurality of electrical wires 7 and each leading end 4c of the plurality of optical fibers 4 from the optoelectrical connector 1B. As a result, it is possible to achieve the stable electrical connection between the electrical wires 7 of the optoelectrical connector 1A and the electrical wires 7 of the optoelectrical connector 1B, and the stable optical coupling between the optical fibers 4 of the optoelectrical connector 1A and the optical fibers 4 of the optoelectrical connector 1B.

In the optoelectrical connector 1A, the pressing part 40 is configured to be pressable against at least one of each leading end 7a of the plurality of electrical wires 7 or each leading end 4c of the plurality of optical fibers 4 along the X direction toward the optoelectrical connector 1B so that the magnitude of the resistive force F2 applied to each leading end 7a of the plurality of electrical wires 7 from the optoelectrical connector 1B and the magnitude of the resistive force F1 applied to each leading end 4c of the plurality of optical fibers 4 from the optoelectrical connector 1B approximate each other. In this instance, at the first face 21 of the housing 20, the load is uniformly applied to each leading end 7a of the plurality of electrical wires 7 and each leading end 4c of the plurality of optical fibers 4 from the optoelectrical connector 1B. Therefore, it is possible to achieve the stable optical coupling between the optical fibers 4 of the optoelectrical connector 1A and the optical fibers 4 of the optoelectrical connector 1B, and the stable electrical connection between the electrical wires 7 of the optoelectrical connector 1A and the electrical wires 7 of the optoelectrical connector 1B. The stable connection can be thus secured as well as both the optical fiber wires and the metal wires are provided in one connector, and connection reliability between the optical fiber wires and between the metal wires can be improved.

In the optoelectrical connector 1A, each leading end 4c of the plurality of optical fibers 4 is included in at least one optical fiber array 5 extending along the Y direction at the first face 21 of the housing 20. Each leading end 7a of the plurality of electrical wires 7 is included in a plurality of signal line arrays 10 extending along the Y direction and being adjacent to each other in the Z direction at the first face 21 of the housing 20. In this instance, at the first face 21 of the housing 20, the leading ends 4c of the plurality of optical fibers 4 are clustered within a predetermined region, and the leading ends 7a of the plurality of electrical wires 7 are clustered within another region. Therefore, the magnitude of the resistive force F1 applied to each leading end 4c of the plurality of optical fibers 4 from the optoelectrical connector 1B and the magnitude of the resistive force F2 applied to each leading end 7a of the plurality of electrical wires 7 from the optoelectrical connector 1B can be made to approximate each other more easily. As in an optoelectrical connector 101A according to a first modification described later, it is possible to collectively press the individual leading ends 7a of the plurality of electrical wires 7 with one spring member.

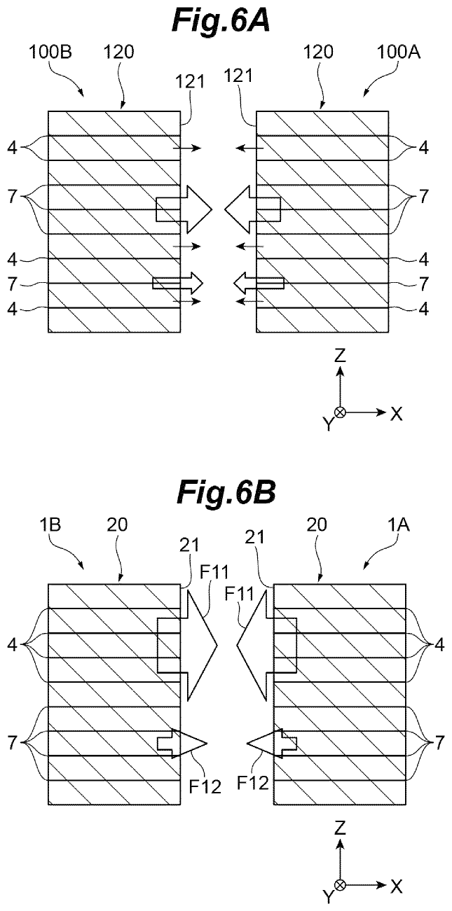

The above-described functional effect will be described in detail with reference to FIGS. 6A and 6B. FIG. 6A is a schematic cross-sectional view illustrating an optoelectrical connector 100A and an optoelectrical connector 100B of a comparative example. FIG. 6B is a schematic cross-sectional view illustrating the optoelectrical connector 1A and the optoelectrical connector 1B of the present embodiment. In the optoelectrical connectors 100A and 100B according to the comparative example, a plurality of optical fibers 4 are not clustered within one region. A plurality of electrical wires 7 are not clustered within one region. As a result, when a resistive force between the optical fibers 4 is greater than a resistive force between the electrical wires 7, the magnitude of the resistive force at a first face 121 varies for each position. Therefore, the load for each position at the first face 121 of a housing 120 is unstable. In contrast, in the optoelectrical connectors 1A and 1B of the present embodiment, the plurality of optical fibers 4 are clustered within a predetermined region, and the plurality of electrical wires 7 are clustered within another region. As a result, even though the resistive force between the optical fibers 4 is greater than the resistive force between the electrical wires 7, the load for each position at the first face 21 of the housing 20 is stable. Thus, it is easy to provide the pressing members 41 and 42 with a structure in which one of a load F11 or a load F12 is approximated (corrected) to the other of the load F11 or the load F12.

In the optoelectrical connector 1A, the pressing part 40 includes the pressing members 42 each of which is configured to be pressable against each leading end 7a of the plurality of electrical wires 7 along the X direction toward the optoelectrical connector 1B. In this instance, it is possible to increase the resistive force F2 applied to each leading end 7a of the plurality of electrical wires 7 from the optoelectrical connector 1B.

In the optoelectrical connector 1A, the pressing part 40 includes the pressing members 41 each of which is configured to be pressable against each leading end 4c of the plurality of optical fibers 4 along the X direction toward the optoelectrical connector 1B. In this instance, it is possible to increase the resistive force F1 applied to each leading end 4c of the plurality of optical fibers 4 from the optoelectrical connector 1B.

In the optoelectrical connector 1A, the magnitude of the force with which each pressing member 42 presses each leading end 7a of the plurality of electrical wires 7 is different from the magnitude of the force with which each pressing member 41 presses each leading end 4c of the plurality of optical fibers 4. In this instance, when the resistive force F1 applied to each leading end 4c of the plurality of optical fibers 4 from the optoelectrical connector 1B is different from the resistive force F2 applied to each leading end 7a of the plurality of electrical wires 7 from the optoelectrical connector 1B, the magnitude of the resistive force F1 applied to the plurality of optical fibers 4 and the magnitude of the resistive force F2 applied to the plurality of electrical wires 7 can be made to approximate each other.

In the optoelectrical connector 1A, the force with which each pressing member 42 presses each leading end 7a of the plurality of electrical wires 7 is greater than the force with which each pressing member 41 presses each leading end 4c of the plurality of optical fibers 4. In this instance, when the resistive force F2 applied to each leading end 7a of the plurality of electrical wires 7 from the optoelectrical connector 1B is smaller than the resistive force F1 applied to each leading end 4c of the plurality of optical fibers 4 from the optoelectrical connector 1B, the magnitude of the resistive force F1 applied to the plurality of optical fibers 4 and the magnitude of the resistive force F2 applied to the plurality of electrical wires 7 can be made to approximate each other.

In the optoelectrical connector 1A, the housing 20 includes the sub-connectors 3A provided with the plurality of through holes 26 and the sub-connectors 2A provided with the plurality of through-holes 25. In this instance, only the leading ends 4c of the plurality of optical fibers 4 are arranged at the first face 21 of the sub-connectors 2A, and only the leading ends 7a of the plurality of electrical wires 7 are arranged at the first face 21 of the sub-connectors 3A. Therefore, the load is uniformly applied at the first face 21 of the sub-connectors 2A and at the first face 21 of the sub-connectors 3A from the optoelectrical connector 1B.

The optoelectrical connector 1A is provided with at least one guide hole 28 configured to allow insertion of the guide pin 70 to position the housing 20. Each of the plurality of through-holes 25 and the plurality of through-holes 26 extends along the X direction and penetrates the housing 20. In this instance, each leading end 7a of the plurality of electrical wires 7 or each leading end 4c of the plurality of optical fibers 4 can be positioned with respect to the optoelectrical connector 1B with higher accuracy.

Although the optoelectrical connector according to the present disclosure has been described in detail as described above, the present invention is not limited to the above embodiment, and can be applied to various embodiments and modifications. Specifically, in the above-described embodiment, both the pressing members 41 and the pressing members 42 are provided in the optoelectrical connector 1A, but the present invention is not limited thereto. For example, when the pressing part 40 is not provided, the magnitude of the resistive force F1 applied to the plurality of optical fibers 4 may be greater than the magnitude of the resistive force F2 applied to the plurality of electrical wires 7. In this instance, only the pressing members 42 that respectively press the plurality of electrical wires 7 may be provided. Therefore, the magnitude of the resistive force F2 applied to the plurality of electrical wires 7 can be increased to approximate the resistive force F2 to the resistive force F1.

For example, when fitting force between the optical fibers 4 is smaller than the fitting force between the electrical wires 7, only the pressing members 41 that respectively press the plurality of optical fibers 4 may be provided. When the pressing part 40 is not provided, the magnitude of the resistive force F2 applied to the plurality of electrical wires 7 may be greater than the magnitude of the resistive force F1 applied to the plurality of optical fibers 4. In this instance, only the pressing members 41 that respectively press the plurality of optical fibers 4 may be provided. Therefore, the magnitude of the resistive force F1 applied to the plurality of optical fibers 4 can be increased to approximate the resistive force F1 to the resistive force F2.

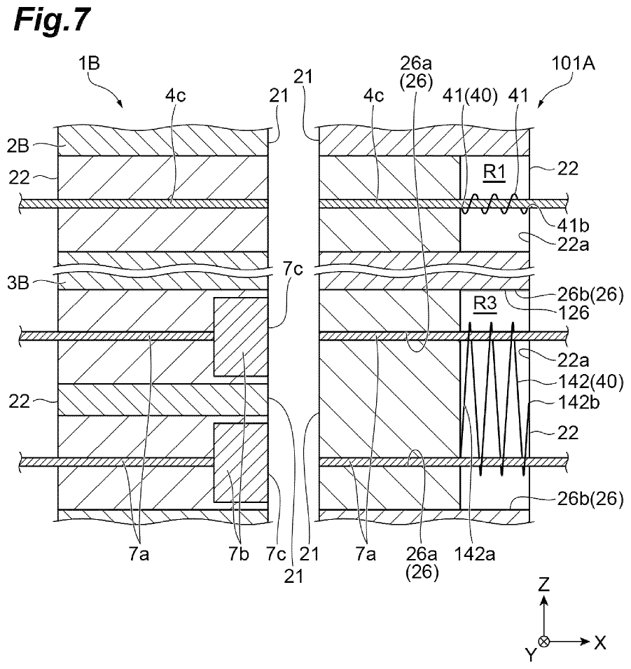

In the above-described embodiment, although the plurality of pressing members 42 press the plurality of electrical wires 7 respectively, one pressing member 142 may press the plurality of electrical wires 7. FIG. 7 is a schematic cross-sectional view illustrating an optoelectrical connector 101A according to a first modification. In the optoelectrical connector 101A according to the first modification, the pressing part 40 includes a pressing member 142 that presses against leading ends 7a of the plurality of electrical wires 7 toward the optoelectrical connector 1B. For example, second hole portions 26b of a plurality of through-holes 26 communicate with each other in the Z direction to form a hole portion 126. The hole portion 126 defines an internal space R3. The pressing member 142 is configured to be pressable against the individual leading ends 7a of the two electrical wires 7 arranged in the Z direction toward the optoelectrical connector 1B. Aleading end 142a of the pressing member 142 is connected to the individual leading ends 7a of the two electrical wires. A tail end 142b of the pressing member 142 is connected to an inner surface 22a of a second face 22. In this instance, since the plurality of electrical wires 7 can be pressed by one pressing member 142, the magnitude of the resistive force F1 applied to the plurality of optical fibers 4 and the magnitude of the resistive force F2 applied to the plurality of electrical wires 7 can be made to approximate each other more easily. Similarly, although the plurality of pressing members 41 press the plurality of optical fibers 4 respectively, one pressing member 41 may press the plurality of optical fibers 4.

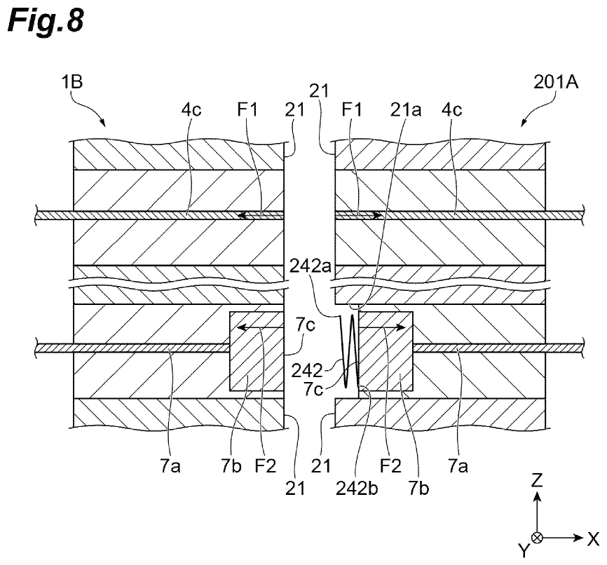

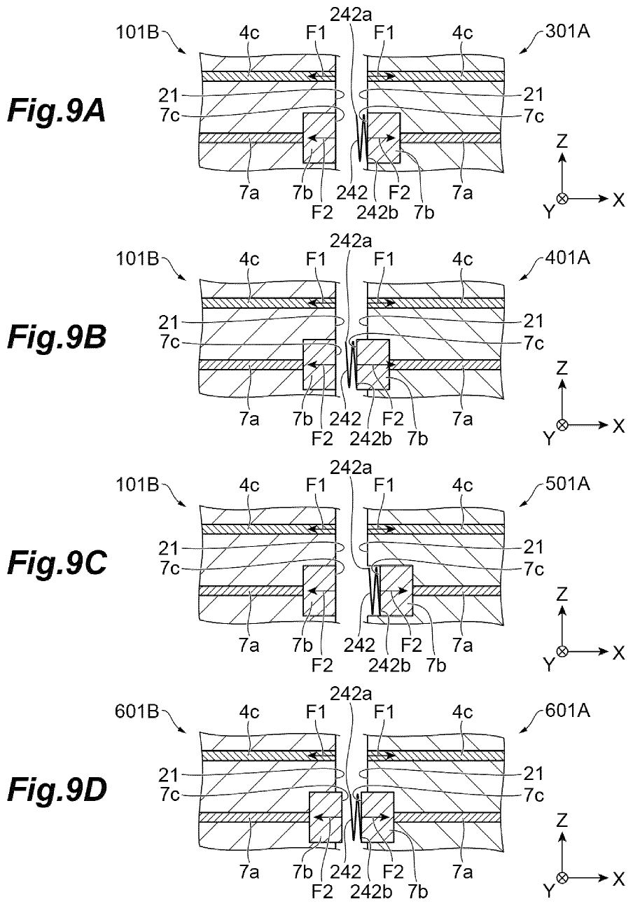

In the above-described embodiment, although each pressing member 42 presses each leading end 7a of the electrical wires 7 toward the optoelectrical connector 1B in the internal space R2 of each sub-connector 3A, the present invention is not limited thereto. FIG. 8 is a schematic cross-sectional view illustrating an optoelectrical connector 201A according to a second modification and the optoelectrical connector 1B. FIGS. 9A to 9D are schematic cross-sectional views illustrating optoelectrical connectors 301A, 401A, 501A, and 601A and an optoelectrical connector 101B, according to a third modification to a sixth modification.

In the optoelectrical connectors 201A, 301A, 401A, 501A, and 601A in FIGS. 8 and 9A to 9D, each leading end 7a of a plurality of electrical wires 7 has a terminal 7b. A pressing part 40 includes a plurality of pressing members 242 each of which presses each terminal 7b of the plurality of electrical wires 7 along the X direction. Each of the pressing members 242 is provided at a leading end face 7c of each terminal 7b of the electrical wires 7. A tail end 242b of each pressing member 242 is connected to the leading end face 7c. Each of the pressing members 242 extends along the X direction. When the optoelectrical connectors 201A, 301A, 401A, 501A and 601A are fitted to optoelectrical connectors 1B, 101B, and 601B, the leading end 242a of the pressing member 242 comes into contact with each of the optoelectrical connectors 1B, 101B, and 601B and presses the terminal 7b of the optoelectrical connector 1A and each terminal 7b of the optoelectrical connector 1B along the X direction. Therefore, it possible to increase the resistive force F2 applied to each terminal 7b of the electrical wires 7 from the optoelectrical connector 1B by each pressing member 242 provided between the terminals 7b.

As illustrated in FIG. 8, in the optoelectrical connector 201A, a leading end face 7c of each terminal 7b forms the bottom surface of a recess 21a formed at the first face 21 of the optoelectrical connector 201A. As a result, by moving the terminals 7b away from each other, the displacement amount of the pressing member 242 provided between the terminals 7b can be decreased, and the force with which the pressing member 242 presses the terminals 7b of the electrical wires 7 can be reduced. In this manner, the mounting position of each sub-connector 3A may be adjusted in advance to cause the place where the terminals come into contact with each other to be moved away from each other.

In the optoelectrical connector 201A, the leading end face 7c of each terminal 7b may protrude from the first face 21 of the optoelectrical connector 201A. As a result, by the terminals 7b approaching each other, the displacement amount of the pressing member 242 provided between the terminals 7b can be increased, and the force with which a pressing member 242 presses the terminals 7b of the electrical wires 7 can be increased. As a result, it is possible to further increase the resistive force F2 applied to the terminal 7b of the electrical wires 7 from the optoelectrical connector 1B. In this manner, the mounting position of each sub-connector 3A may be adjusted in advance to cause the places where the terminals come into contact with each other to approach each other.

Unlike the optoelectrical connectors 1A, 101A, and 201A, the optoelectrical connectors 301A, 401A, 501A, and 601A in FIGS. 9A to 9D do not include sub-connectors 2A and 3A. Similarly, the optoelectrical connectors 101B and 601B do not include sub-connectors 2B and 3B. Therefore, the optoelectrical connectors 1A, 101A, and 201A may not be divided into a plurality of sub-connectors.

As illustrated in FIG. 9A, in the optoelectrical connector 301A, a leading end face 7c of each terminal 7b is flush with a first face 21 of the optoelectrical connector 301A. On the other hand, as illustrated in FIGS. 8 and 9B to 9D, in the optoelectrical connectors 201A, 301A, 401A, 501A, and 601A, the position of each leading end 7a of the plurality of electrical wires 7 in the X direction and the position of each leading end 4c of the plurality of optical fibers 4 in the X direction may be different from each other. In this instance, the magnitude of the resistive force F2 applied to each leading end 7a of the plurality of electrical wires 7 from the optoelectrical connector 1B can be adjusted separately from the magnitude of the resistive force F1 applied to each leading end 4c of the plurality of optical fibers 4 from the optoelectrical connector 1B.

In the optoelectrical connector 401A in FIG. 9B, a leading end face 7c of each terminal 7b may protrude from a first face 21 of a sub-connector 3A. As a result, the terminals 7b approach each other. As a result, the displacement amount of the pressing member 242 provided between the terminals 7b can be increased, and the force with which the pressing member 242 presses the terminals 7b of the electrical wires 7 can be increased. As a result, it is possible to further increase the resistive force F2 applied to the terminal 7b of the electrical wires 7 from the optoelectrical connector 1B.

As illustrated in FIG. 9C, in the optoelectrical connector 501A, a leading end face 7c of each terminal 7b forms the bottom surface of a recess 21a formed at the first face 21 of the optoelectrical connector 501A. As a result, by moving the terminals 7b away from each other, the displacement amount of the pressing member 242 provided between the terminals 7b can be decreased, and the force with which the pressing member 242 presses the terminals 7b of the electrical wires 7 can be reduced.

In the optoelectrical connector 601A in FIG. 9D, a leading end face 7c of a terminal 7b may protrude from a first face 21 of the optoelectrical connector 601A. In the optoelectrical connector 601B, a leading end face 7c of a terminal 7b may protrude from a first face 21 of the optoelectrical connector 601B. Therefore, the first faces 21 of the housings 20 of the optoelectrical connector 601A and the optoelectrical connector 601B protrude to cause the terminals 7b to approach each other. Therefore, by the terminals 7b approaching each other, it possible to further increase the resistive force F2 applied to each terminal 7b of the electrical wires 7 from the optoelectrical connector 1B by each pressing member 242 provided between the terminals 7b.

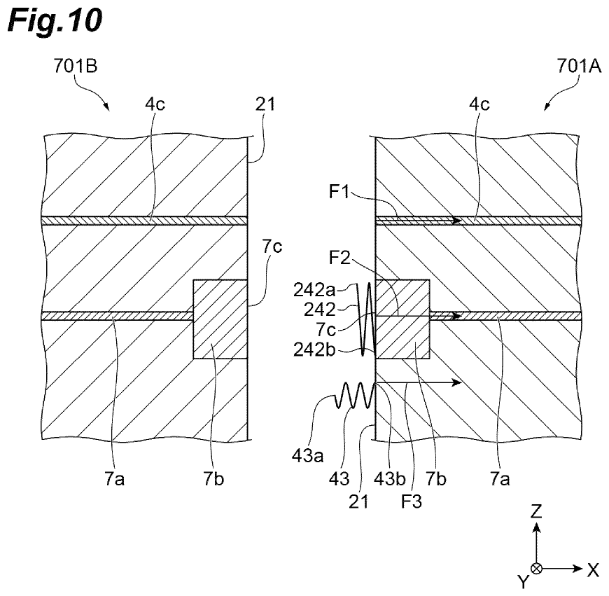

In each of the above-described modifications, the pressing part 40 may further include a pressing member 43 adjacent to each terminal 7b of the electrical wires 7 at the first face 21. FIG. 10 is a schematic cross-sectional view illustrating an optoelectrical connector 701A according to a seventh modification. The optoelectrical connector 701A does not include sub-connectors 2A and 3A. The optoelectrical connector 701B does not include sub-connectors 2B and 3B. A tail end 43b of the pressing member 43 is connected to a first face 21 of the optoelectrical connector 701A. When the optoelectrical connector 701A is fitted to the optoelectrical connector 701B, a leading end 43a of the pressing member 43 comes into contact with a first face 21 of the optoelectrical connector 701B. In this manner, a spring member assisting an increasing in the load may be provided on the metal side. As a result, the pressing member 43 increases a resistive force F3 applied to the first face 21 of the optoelectrical connector 701A in the vicinity of the terminal 7b of the electrical wire 7 from the first face 21 of the optoelectrical connector 701B. As a result, the total resistive force of the resistive force F3 and the resistive force F2 applied to the electrical wire 7 approximates the resistive force F1 applied to the optical fiber 4. Therefore, the load is uniformly applied to the optoelectrical connector 701A from the optoelectrical connector 701B at the first face 21 of the optoelectrical connector 701A. The pressing member 43 may be provided to be adjacent to the terminal 7b of the electrical wire 7 at the first face 21 of the optoelectrical connector 701B.

In the above-described embodiment and each of the modifications, the magnitude of the pressing force by each of the pressing members 42 and 242 may be modified by a method other than the above. For example, the structures of the pressing members 42 and 242 may be modified as long as the size of the housing 20 is ensured to allow the force with which the pressing members 42 and 242 press the leading ends 7a of the electrical wires 7 to be stronger. For example, when the pressing members 42 and 242 are springs, the width intersecting the extending direction of each spring may be increased, a rib may be provided at the center of each spring, or each spring may be warped.

In the above-described embodiment and each of the modifications, the magnitude of the force with which the pressing member 41 presses each leading end 4c of the optical fibers 4 may be modified by a method other than the above. For example, the magnitude of the force with which the pressing member 41 presses each leading end 4c of the optical fibers 4 may be modified in the same manner as the pressing members 42 and 242. For example, the magnitude of the force with which the pressing member 41 presses each leading end portion 4c of the optical fibers 4 may be modified by adjusting the pressing amount between the optical fibers 4. As an example, counter boring may be carried out on the first face 21 of the housing 20 to move the optical fibers 4 away from each other, thereby reducing the pressing amount of the optical fibers 4. In this instance, the resistive force F1 applied to the optical fibers 4 decreases.

What is claimed is:

1. An optoelectrical connector comprising:
a plurality of electrical wires each extending along a first direction;
a plurality of optical fibers each extending along the first direction;
a housing including a plurality of electrical wire housing parts respectively housing the plurality of electrical wires, and a plurality of optical fiber housing parts respectively housing the plurality of optical fibers; and
a pressing part configured to be pressable against at least one of the plurality of electrical wires or the plurality of optical fibers along the first direction,
wherein each leading end of the plurality of electrical wires and each leading end of the plurality of optical fibers are exposed at an end face of the housing.

2. The optoelectrical connector according to claim 1,
wherein the pressing part is configured to be pressable against at least one of each leading end of the plurality of electrical wires or each leading end of the plurality of optical fibers along the first direction so that a magnitude of a resistive force applied to each leading end of the plurality of electrical wires from a mating connector and a magnitude of a resistive force applied to each leading end of the plurality of optical fibers from the mating connector approximate each other.

3. The optoelectrical connector according to claim 1,
wherein each leading end of the plurality of optical fibers is included in at least one optical fiber array extending along a second direction intersecting the first direction at the end face of the housing, and
wherein each leading end of the plurality of electrical wires is included in a plurality of signal line arrays extending along the second direction and being adjacent to each other in a third direction intersecting the second direction at the end face of the housing.

4. The optoelectrical connector according to claim 1,
wherein the pressing part further includes a first pressing part configured to be pressable against each leading end of the plurality of electrical wires toward a mating connector along the first direction.

5. The optoelectrical connector according to claim 4,
wherein the pressing part further includes a second pressing part configured to be pressable against each leading end of the plurality of optical fibers toward the mating connector along the first direction.

6. The optoelectrical connector according to claim 5,
wherein a magnitude of a force with which the first pressing part presses each leading end of the plurality of electrical wires is different from a magnitude of a force with which the second pressing part presses each leading end of the plurality of optical fibers.

7. The optoelectrical connector according to claim 6,
wherein the magnitude of the force with which the first pressing part presses each leading end of the plurality of electrical wires is greater than the magnitude of the force with which the second pressing part presses each leading end of the plurality of optical fibers.

8. The optoelectrical connector according to claim 5,
wherein the first pressing part and the second pressing part are elastic bodies.

9. The optoelectrical connector according to claim 8,
wherein the pressing part includes the first pressing part provided at each of the leading ends of the plurality of electrical wires and the second pressing part provided at each of the leading ends of the plurality of optical fibers, and a spring constant of the first pressing part is different from a spring constant of the second pressing part.

10. The optoelectrical connector according to claim 1,
wherein a position of each leading end of the plurality of electrical wires in the first direction and a position of each leading end of the plurality of optical fibers in the first direction are different from each other.

11. The optoelectrical connector according to claim 1,
wherein the housing further includes a first sub-connector provided with the plurality of electrical wire housing parts and a second sub-connector provided with the plurality of optical fiber housing parts.

12. The optoelectrical connector according to claim 1, further comprising at least one guide hole configured to allow insertion of a guide pin to position the housing,
wherein at least one of the plurality of electrical wire housing parts or the plurality of optical fiber housing parts is a plurality of through-holes each of which extends along the first direction and penetrates the housing.

13. The optoelectrical connector according to claim 1,
wherein the plurality of electrical wires includes a plurality of electrical wires of a flexible flat cable.
